(19) United States
(12) Patent Application Publication
(10) Pub. No.: US 2006/0249094 A1
(43) Pub. Date: Nov. 9, 2006

(54) Dog self-cleaning brush

(76) Inventor: Donald R. Hellyer, Quincy, IL (US)

Correspondence Address: Donald R. Hellyer, 3207 Brentwood Dr., Quincy, IL, 62301, US

(21) Appl. No.: 11/098,287

(22) Filed: May 5, 2005

(51) Int. Cl. A01K 13/00

(52) U.S. Cl. 119/631

(57) ABSTRACT

The patent search disclosed many self-cleaning pet brushes. Most use a perforated pad over the bristles. Our method has a wire grill that sits flush with the base. It is held in place by hinges. A flipper button next to the handle flips the hair off into a waste container. This principle is applied to both the pet cleaner and the horse brush cleaner. Both the work grill for pet brush cleaning and the plate over the serrated blades for horse brush cleaning are held in place by a magnet (ear ring) type. This holds the grill and the plate in a firm position while in use. We found no self cleaning brushes for horses—only a hair shredder issued to a Allen Simon . . . U.S. Pat. No. D481-8365 Dated Nov. 14, 2003. The combination of a pet brush and a horse brush is unique and no patent has been found using this design.

The inventor makes the following claims:

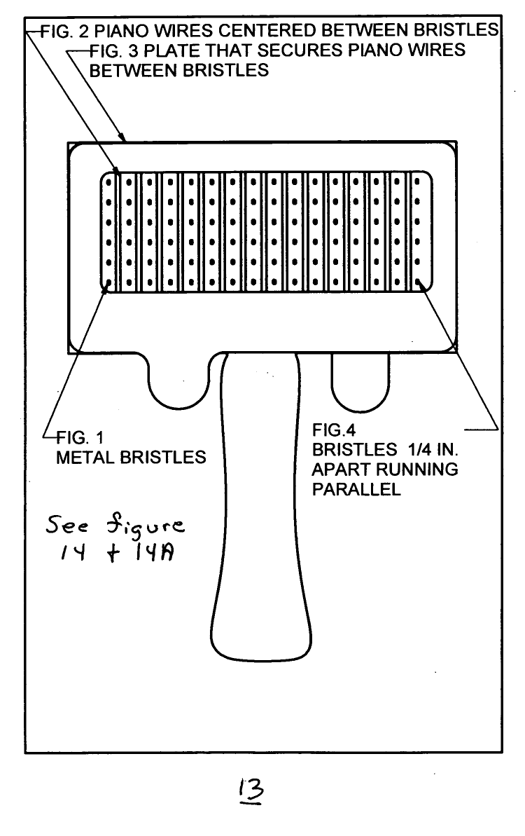

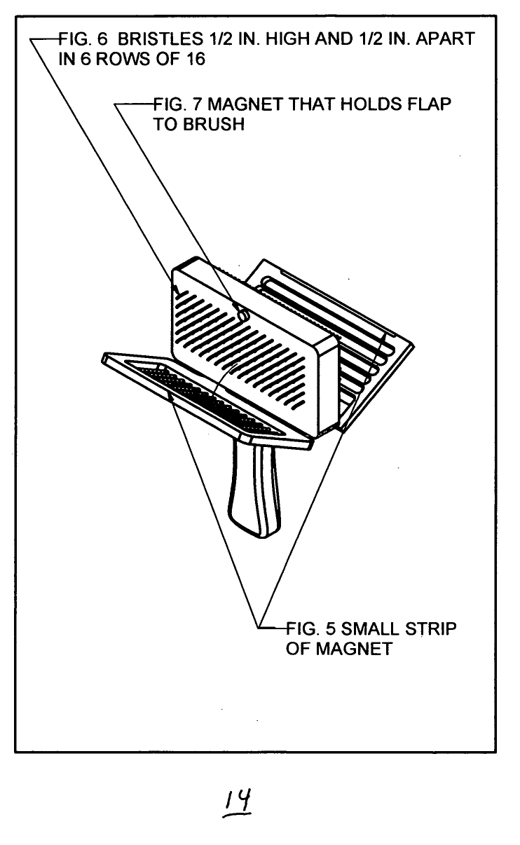

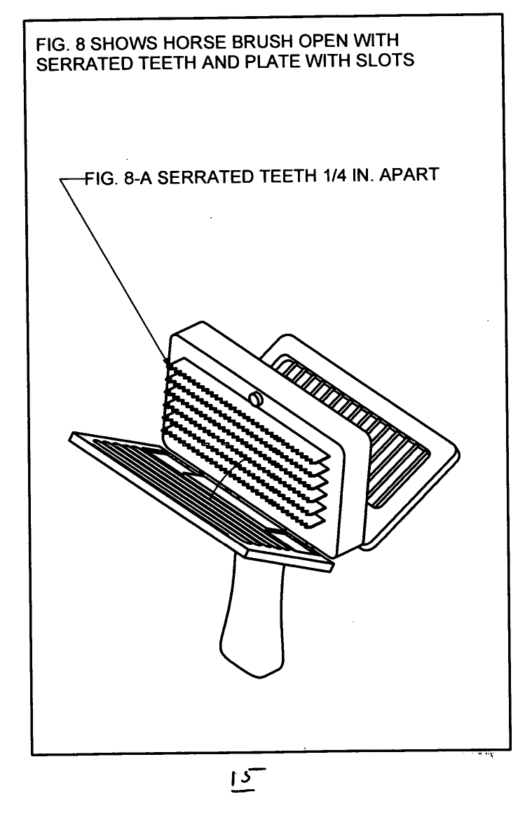

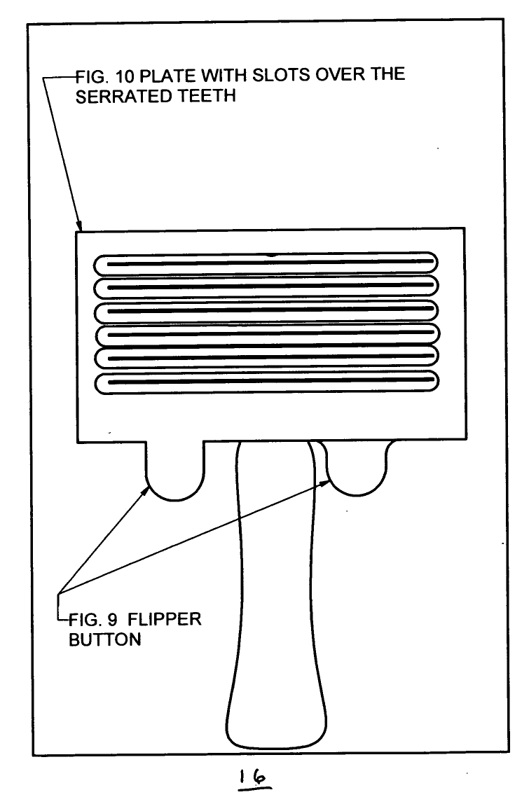

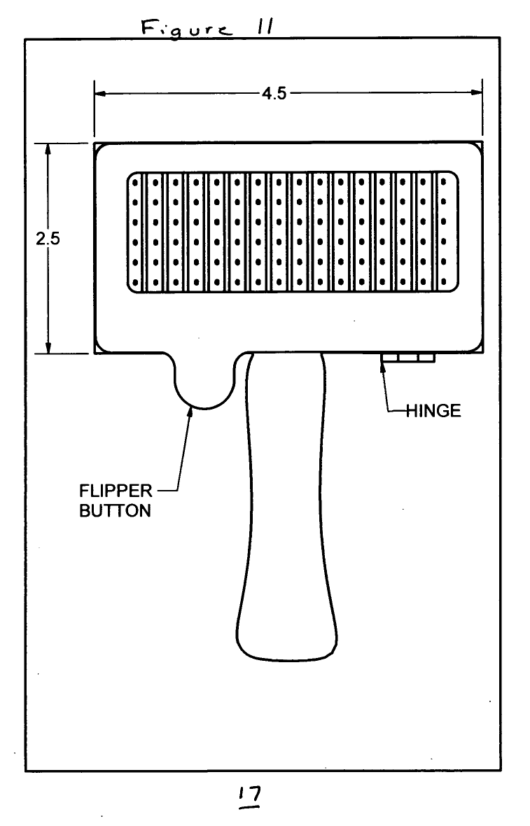

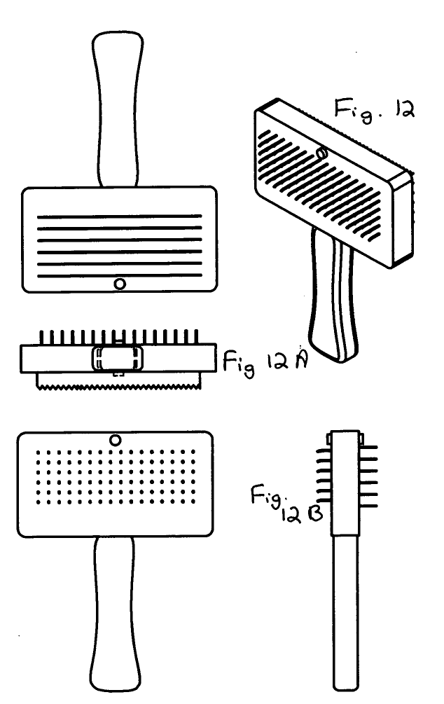

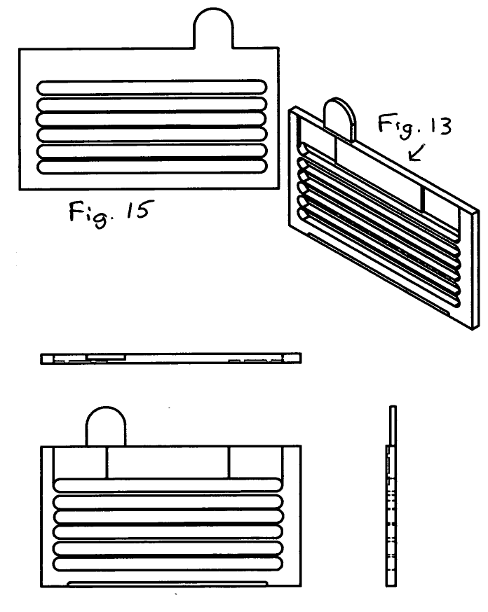

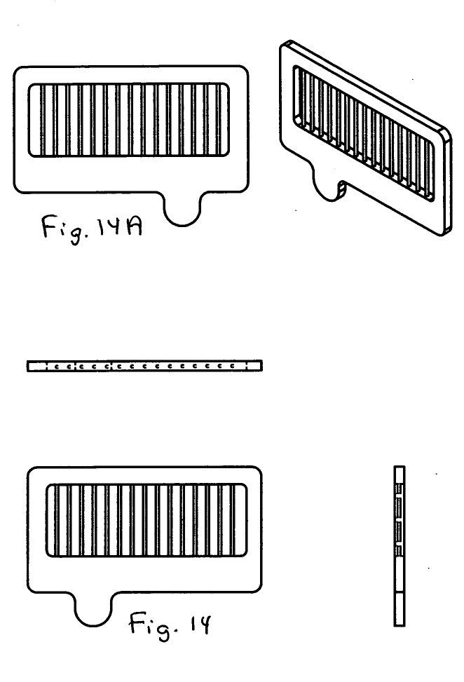

That this is a dual purpose brush—one side for dog grooming, the other side for horse grooming. The inventor claims that the method used to clean the grooming brush for both dogs and horses is a new conception. The method of quick brush cleaner is fast and does not require the groomer to pull the hair from the brush with the groomer's hand. That is one of the amenities of my design. Almost all the patents granted have a similar way of removing the hair from the bristles of the brush that is to manually pull the pad from the brush bristles. My method simply requires the groomer to depress the trigger button and the hair is flipped into a waste container. Also we could not find in our search any brush cleaner for the grooming brush for horses. The reason for having a grill to dispose of hair on the dog brush and to have a plate with slotted openings over the serrated teeth. The horse grooming side is due to the texture of dogs hair as opposed to horses hair. Also three is not grooming brush that has one side of the brush for horses and one side of the brush for dog grooming that we could find. The groomers at the animal shelter were wearing rubber gloves. The dogs had mange and other skin diseases. Recently children from a petting zoo in St. Louis and in Wisconsin were hospitalized with kidney failure. The got a disease from the animals. The idea was conceived to have a brush that could be cleaned without the hair touching the groomer's hand. That is what my invention accomplished. A flipper on the plate of the brush, using a grill, flips the hair into a container and never touches the groomer's hand. There are many patents granted for the self-grooming methods. Almost all use a felt on rubber pad over the wire bristles. When the pad is saturated with hair it is removed from the brush. That is an effective way to clean the brush, but not practical. It is time consuming and requires on inventory of pads. Also it is interesting to note that a self-cleaning brush so designed can not be found in any pet store or Wal-Mart. My system cleans the brush in a split second. The grill on the dog grooming brush is hinged to the plate. A flipper button, when depressed forces the grill upward, discharging the hair on the brush. FIG. 1 shows 15 rows of wire bristles that are parallel. Centered between each row of bristles is a piano wire that is embedded on each end and on the side with a thin strip (FIG. 2). FIG. 3 shows the plate that covers the bristles and lays flat on the bristle plate. FIG. 4 shows the piano wire centered between the bristles running parallel with the bristles the length of the pad. FIG. 5 shows the brush as it is opened on each side. One side shows the bristles. The other side shows the serrated teeth of the horse grooming brush. FIG. 5A shows the serrated teeth and the plate with slots that covers the serrated teeth. The plate with the slots (opening) fits snuggly over the plate holding the serrated teeth. When the flipper button is depressed the plate with the slots flips upward, discharging the hair from the brush. FIG. 6 shows a magnet that is inserted in the plate. Directly above the magnet is a magnetic strip. When the plate with the slots is released it goes down flat with the plate. This magnetic strip plus the magnet holds the brush firmly while in use. FIG. 6A shows the location of the magnetic tape on the bristles of the dog brush. FIG. 7 shows the magnetic tape on the brush for the horse grooming. FIG. 8 shows the 6 rows of serrated teeth on the horse grooming brush. FIG. 9 shows the placement of the magnet. FIG. 10 shows the placement of the magnetic strip. FIG. 11 shows the dimensions of the brush, also shows the placement of the flipper button. It also shows the hinge that permits the wire grill or slotted plate to be flipped upward when the flipper button is depressed. FIG. 12 and 12A show the position of the magnet and magnetic strip. FIG. 12B shows side view of bristles. FIG. 13 shows placement of magnetic strip. FIG. 14 and 14A shows placement next to handle of flipper buttons. FIG. 15 shows the slotted plate over the serrated teeth of the horse brush. To further explain the method of hair removal from the brush, I will explain more in detail. Next to the handle on each side is one hinge. The flipper button activated the grill and slotted plates. When activated, the hinges permit the hair to be discharged off of the brush. When the flipper button is released the grill and slotted plate falls back flat on the plate holding the wire bristles of the dog brush and the slotted plate on the horse brush. They are then held firmly in place by the magnetic attachment. The brush and the slotted plates may be made of plastic. The bristles must be made of wire. The serrated teeth on the horse brush must be made of metal.

### SUMMARY

The reason that there are two methods of removing the hair from the horse side and the dog side of the brush is due to the texture of the animal hair. The grill method for dogs does not work for horses. Therefore I designed different methods of hair removal for each side of the brush. To summarize the method of removal of the horse hair, the serrated teeth (metal) work excellently for horse grooming. In fact, the patent of currie comb patented in 1884 used this type of serrated teeth which is still used to this date. Again to summarize, there are no patents to clean horse brushes that we could find. There are many self cleaning brushes for dogs. The few patents granted for horse brushes were all design patents. The latest being a patent issued to Allen Simon, U.S. Pat. No. D-481-836-5 dated Nov. 4, 2003. Again their shredding blade is an ornamental design.

1. That the Quickie Brush cleaner is a new and novel conception.

2. That it makes it possible for the groomer to remove the hair from the brush by simply flipping it into a waste container. The groomer does not have to manually pull the hair from the brush or required to pull the pads manually.
The patents granted mostly deal with pads over the wire bristles that must be removed manually. Our system simply requires the plate or grill to be flipped upward discharging the hair from the saturated brush.
